(19) United States
(12) Patent Application Publication
(10) Pub. No.: US 2016/0277372 A1
(43) Pub. Date: Sep. 22, 2016

(54) OPTIMIZATION OF A SECURE CONNECTION WITH ENHANCED SECURITY FOR PRIVATE CRYPTOGRAPHIC KEYS

(71) Applicant: Riverbed Technology, Inc., San Francisco, CA (US)

(72) Inventors: Paras S. Shah, Sunnyvale, CA (US); Abhinav Rai, San Jose, CA (US); Chang Cheng, Pleasanton, CA (US)

(73) Assignee: RIVERBED TECHNOLOGY, INC., San Francisco, CA (US)

(21) Appl. No.: 14/660,067

(22) Filed: Mar. 17, 2015

(51) Int. Cl. H04L 29/06

(52) U.S. Cl. CPC H04L 63/061; H04L 63/0823; H04L 63/0876

(57) ABSTRACT

A system, method, and apparatus are provided for establishing a secure, split-terminated, communication connection between a client and a server (or two other communicants), without exposing to possible compromise one or more private keys used at an intermediate device to establish the communication connection. The private key(s) is or are stored on a key server that is separate from the intermediate device and from any other devices whose private keys are also stored on the key server. During the handshaking to establish the communication connection, one or more handshaking messages (or components of the messages) are submitted to the key server, by the intermediate device, for encryption or decryption with the corresponding key(s). The resulting encrypted or decrypted information is returned to the intermediate device for further action (e.g., to be forwarded or processed).

### BACKGROUND

This disclosure relates to the fields of computer systems and networking. More particularly, a system, method, and apparatus are provided for facilitating optimization of secure network traffic without exposing private cryptographic keys to optimization devices.

Transaction acceleration or communication optimization, such as that described in U.S. Pat. No. 7,120,666 (McCanne), can offer performance improvement for operations across a wide-area network (WAN), but only when the data being communicated is either intelligible (i.e., the acceleration/optimization device can interpret at least parts of the protocol) or repeating (i.e., identical data crosses the network in identical format). The use of secure communication protocols such as SSL (Secure Socket Layer) and TLS (Transport Layer Security) can therefore hinder transaction acceleration, because cryptography (by design) renders encrypted data unintelligible and non-repeating.

A method of using a cooperating pair of transaction accelerators or optimization devices to optimize secure end-to-end communications between a client and a server (or other communicating entities) is described in U.S. Pat. No. 8,613,071 (Day), and involves the use of separate, split-terminated, secure protocol sessions between one acceleration/optimization device and the client, and between the cooperating device and the server.

However, some schemes require an acceleration or optimization device to retain a private key of a server (or other entity) that it supports. Installing a server's private key on the acceleration/optimization device necessarily increases the risk of exposing the key to malicious access. The device may be vulnerable to a remote attack, for example, or may be physically compromised. If the device and server are operated by different organizations, there may also be some reluctance to allow use of the server's private key by someone else.

To avoid sharing a private key, some organizations forego optimization of secure connections, which can have a substantial impact on communication throughput and application performance. Alternatively, an organization may employ anonymous ciphers on its secure connections instead of allowing an acceleration or optimization device to use a server's private key. However, this leaves the system vulnerable to man-in-the-middle (MITM) attacks because of a lack of authentication.

### SUMMARY

In some embodiments, systems, methods, and apparatus are provided for optimizing communications between communicating entities (e.g., a server and client) exchanged over a secure communication connection (e.g., a connection secured by TLS or SSL), without sharing a private cryptographic key with an intermediate device (e.g., an optimization device) that performs or supports the optimization. In these embodiments, private keys of a server, the intermediate device, and/or some other entity or entities, are installed on a key server that is separate from the optimization devices and that may be isolated from any wide-area networks (WANs) and/or other communication links that carry the optimized communication traffic, such as the Internet.

In these embodiments, the secure communication connection is split-terminated at one or more intermediate network devices that optimize data exchanged across the connection. Private cryptographic keys used by the intermediate devices, and/or keys used by other entities, are stored on the key server. When information needs to be encrypted or decrypted with such a private key, such as to establish the secure, split-terminated connection, the information is delivered to the key server, which encrypts or decrypts it as desired and returns the result.

### DESCRIPTION OF THE FIGURES

FIG. 1 is a block diagram depicting a communication environment in which secure communications are optimized without exposing a private cryptographic key, according to some embodiments.

FIG. 2 is a time sequence diagram demonstrating a handshaking process for establishing a split-terminated secure communication connection between a client and a server, without exposing a private cryptographic key, according to some embodiments.

FIG. 3 is a block diagram of an apparatus for facilitating a secure split-terminated client-server communication connection, without exposing a private cryptographic key, according to some embodiments.

FIG. 4 is a block diagram of a network intermediary with which a secure split-terminated client-server communication connection may be established, without exposing a private cryptographic key, according to some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In embodiments described herein, a system, methods, and apparatus are provided for enabling split-termination and optimization of a secure communication connection (e.g., a client-server network connection), without exposing or making vulnerable to compromise a private cryptographic key of a communicating entity or a device that performs or supports the optimization. The end-to-end connection may be secured via TLS (Transport Layer Security), SSL (Secure Sockets Layer), or some other suitable protocol. Either or both communicating entities may be authenticated. Although implementations of these embodiments are described below as they may operate for a client-server communication connection, in other implementations the communicating entities may have some other relationship (e.g., peer-to-peer).

In some embodiments, one or more intermediate entities (e.g., a cooperating pair of transaction accelerators) are positioned within a communication path between a client and a server. During the handshaking process, these entities passively observe the exchange of messages, and may capture some data without impeding or altering the process, or may modify the handshaking process in some way(s), in order to split-terminate the client/server communication connection. After the connection is established, however, they are able to participate in the connection in order de-duplicate information exchanged between the client and server and/or optimize their communications in some other manner.

Private keys used in the creation or maintenance of the secure connection, however, are stored on a key server that is accessible to one or both of the intermediate entities. When one of these keys is needed to encrypt or decrypt information, the entity requiring such action submits the information to the key server, possibly with other information (e.g., a certificate associated with the public key associated with the private key). The key server applies the corresponding key and returns the decrypted or encrypted result.

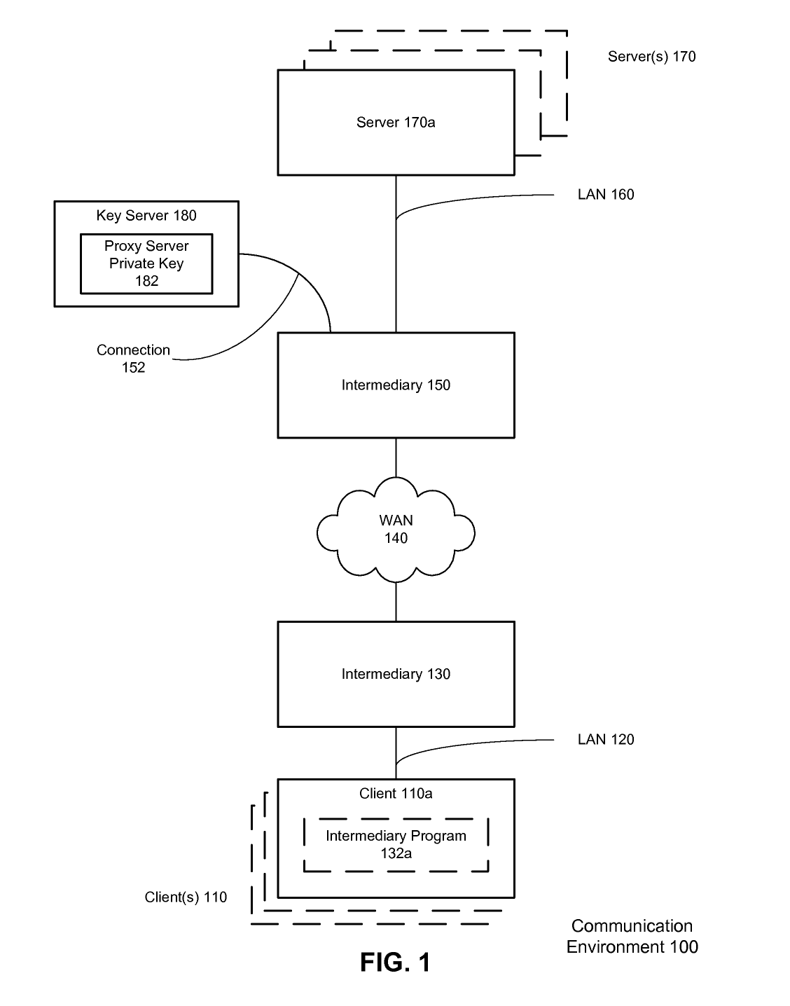

FIG. 1 illustrates an environment in which some embodiments described herein may be implemented. In this environment, clients 110 (e.g., client 110a) communicate with servers 170 (e.g., server 170a) in client-server relationships established via TLS, SSL, or some other secure protocol. Intermediaries 130, 150 are situated in a path of communication between client 110a and server 170a.

Intermediaries 130, 150 are coupled via WAN (Wide Area Network) 140, which may include the Internet, while client 110a is coupled to intermediary 130 via LAN (Local Area Network) 120 and server 170a is coupled to intermediary 150 via LAN 160. Thus, intermediary 130 is relatively local to client 110a, while intermediary 150 is relatively local to server 170a (e.g., within the same data center).

In the embodiment of FIG. 1, communications traversing WAN 140 are characterized by relatively high latency and low bandwidth in comparison to communications transiting LANs 120, 160. In other embodiments, other types of wired and/or wireless communication links may be employed. For example, LAN 120 and/or LAN 160 may be WANs, a LAN may be a point-to-point link or a WAN, etc.

Intermediary 130 may be termed a “client-side intermediary” (or CSI) and intermediary 150 may be termed a “server-side intermediary” (or SSI) to reflect their relative positions within environment 100, but these terms are not meant to restrict the manner in which either intermediary functions. Although not shown in FIG. 1, additional client side intermediaries may also cooperate with server-side intermediary 150, and/or client-side intermediary 130 may cooperate with other server-side intermediaries.

In some implementations, a client-side intermediary may be installed on a client 110a, as intermediary program 132a for example, particularly if the client is a portable computing device. In these implementations, CSI 130 may be omitted, bypassed, or may operate in a pass-through mode for communications issued from and to client 110a. Reference to a client-side intermediary herein should be interpreted so as to encompass intermediary 130 and/or intermediary program 132a, as appropriate.

In some particular embodiments, intermediaries 130, 150 are Steelhead™ transaction accelerators from Riverbed® Technology, and are configured to optimize communications and applications (e.g., through compression and/or acceleration). Transaction accelerators are referred to in the art by many different terms, including, but not limited to, wide area network (WAN) accelerators, WAN optimizers, WAN optimization controllers (WOCs), wide-area data services (WDS) appliances, WAN traffic optimizers (WTOs), and protocol accelerators or optimizers. In other embodiments, the intermediaries may be configured to perform other operations in addition to or instead of optimization, such as routing, caching, etc.

All communication traffic between client 110a and server 170a may traverse intermediaries 130, 150 (or intermediary program 132a and intermediary 150) in the illustrated embodiment, although this is not required in other embodiments. One or both intermediaries may also handle traffic between client 110a and entities other than server 170a, and/or traffic between server 170a and other entities. In other embodiments, the client and server may also utilize other communication paths that avoid one or both of the intermediaries.

In the embodiment described in FIG. 1, one or more of client 110a, intermediaries 130, 150, and server 170a may be configured with CA (Certificate Authority) digital certificates, which are trusted by the entities and which allow them to verify a digital certificate received from another entity.

For example, server 170a has at least one certificate identifying the server (e.g., a “server certificate”), which has a corresponding private key. Intermediary 150 also has at least one certificate (e.g., a “proxy server certificate”) that identifies the intermediary with the same (common) name as server 170a and that has an associated private key. However, in embodiments described herein, the private key(s) held by intermediary 150, which may include private keys associated with multiple proxy server certificates issued for the intermediary (e.g., with names of multiple servers 170 that the intermediary supports), is or are stored on key server 180.

For example, proxy server private key 182 is the private key associated with the proxy server certificate issued to intermediary 150 with the same (common) name as server 170a, and allows the server-side intermediary to establish communication sessions with clients in the name of the server. Private keys of server 170a, other servers 170, and/or other entities (e.g., a certificate authority) may also be stored on key server 180.

In some implementations, key server 180 is a hardware security module (HSM); in some other implementations it may be a purpose-built cryptographic accelerator. The key server may be tamper-resistant, may retain evidence of tamper attempts, may destroy stored data (e.g., keys) in response to intrusion, and/or feature other means and mechanisms for securely storing and resisting compromise of private cryptographic keys.

In some embodiments, connection 152 between the key server and server-side intermediary is a dedicated point-to-point communication link, and thus the key server may not be accessible via WAN 140 or LAN 160. In other embodiments, connection 152 may comprise a virtual private network or other secure channel within LAN 160 or some other shared link. Thus, in some embodiments, other entities (e.g., server 170a) may communicate with key server 180, via other communication channels or via connection 152.

When intermediary 150 and key server 180 establish their communication connection, they may authenticate each other. The connection may be persistent so as to avoid the overhead involved in re-negotiating a new connection and/or re-authenticating each other.

U.S. Pat. No. 8,613,071, entitled “Split Termination for Secure Communication Protocols,” describes a method for establishing split-terminated communication connections between clients (e.g., clients 110) and servers (e.g., servers 170) that are secured using SSL, TLS, or some other appropriate secure communication protocol.

One method of forming a split-terminated secure communication session between two endpoints (e.g., client 110a and server 170a) involves establishing multiple secure communication sessions involving the two endpoints and one or more intermediaries. Specifically, a client session may be established between the client and one intermediary (e.g., a client-side intermediary), and a server session may be established between the server and the same or a different intermediary (e.g., a server-side intermediary). Thereafter, communications between the server and the client traverse both sessions and can be optimized by the intermediaries.

In embodiments described herein, a server-side intermediary (SSI) receives from a client a request to establish a communication connection with a server for which the intermediary possesses a proxy server certificate, and creates a split-terminated secure connection as summarized above—one server session having a server session key and one client session having a client session key.

In these embodiments, the SSI creates the client session by using the proxy server certificate to mimic the server. Because the private key associated with the proxy server certificate is stored on a key server, the SSI submits to the key server communications that must be decrypted (or encrypted) with that key, such as a message comprising information used to generate a session key. The SSI receives the decrypted (or encrypted) communications and processes (or forwards) them as necessary (e.g., to generate a session key).

After the split-terminated communication connection is established, the SSI may share the client session key with a client-side intermediary (CSI). Thereafter, the CSI can intercept communications from the client to the server, optimize them, and forward them to the SSI for de-optimization and delivery to the server. Communications to the client from the server are intercepted by the SSI, optimized, and forwarded to the CSI for de-optimization and delivery to the client.

No special application, utility, or plug-in need be installed on clients 110 or servers 170 in order for them to participate in secure split-terminated client-server communication connections described herein.

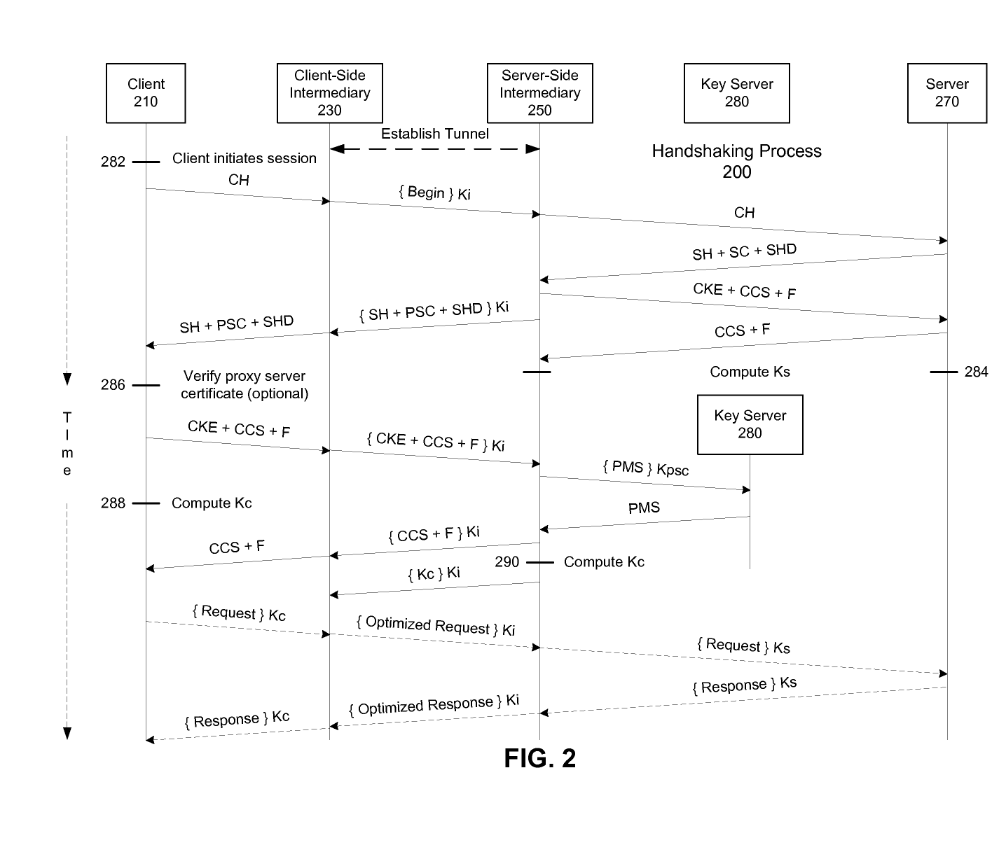

FIG. 2 is a time sequence diagram demonstrating a method of split-terminating a secure end-to-end client-server communication connection without exposing a private cryptographic key to possible compromise or use on a network intermediary, according to some embodiments.

In these embodiments, server 270 communicates with server-side intermediary (SSI) 250 directly or via a LAN, SSI 250 communicates with client-side intermediary (CSI) 230 via a WAN, and CSI 230 communicates with client 210 via a LAN or other communication link. SSI 250 communicates with key server 280 via a dedicated link or other link that is restricted to use by the server-side intermediary and possibly server 270 and/or other entities for which private keys are stored in the key server. The directed vectors between the various entities represent messages involved in handshaking process 200.

Prior to handshaking process 200, server-side intermediary 250 receives a proxy digital certificate in a name of server 270 (e.g., a “proxy server certificate”), and a corresponding or associated private cryptographic key is stored on key server 280. The SSI may receive multiple proxy certificates, and multiple corresponding private keys may be stored on the key server, if the server uses multiple certificates. Thus, in the illustrated embodiment, no private cryptographic key that corresponds to a certificate used to establish the split-terminated communication connection is stored on SSI 250 (or CSI 230).

In the illustrated embodiment, at time sequence 282, the client initiates a secure communication connection with the server. For purposes of clarity, data exchanges between protocol layers up through the transport protocol layer (e.g., TCP) are omitted so that the discussion can be focused on the SSL/TLS handshaking process.

Before time sequence 282 in the illustrated embodiment, or possibly after time sequence 282 in other embodiments, CSI 230 and SSI 250 establish a secure channel or tunnel between them, so as to protect communications exchanged across the WAN or other link that connects the intermediaries. In one implementation, the intermediaries employ TLS or SSL to establish a symmetric key, although in other implementations they may employ a different security scheme.

A cryptographic key used by the intermediaries to encrypt/decrypt messages sent via the tunnel is represented herein as Ki. The tunnel may be used for intermediary communications for any number of client-server connections at any given time, as well as administrative communications between the intermediaries.

In establishing the tunnel, the server-side intermediary may use a digital certificate other than any certificate that will be used to establish the split-terminated connection between client 210 and server 270 (e.g., the proxy server certificate), and which may be referred to as a (server-side) intermediary certificate. The private cryptographic key associated with the intermediary certificate may be stored on key server 280, in which case the key server will be involved in establishing the secure tunnel.

When the client initiates the secure connection, it issues a Client-Hello (CH) message toward the entity with which it wishes to communicate—server 270. The Client-Hello message comprises a client seed (e.g., a 16 or 32 byte random number) that will be used during generation of a session key, and may also include other information, such as protocols/versions it supports, encryption and/or compression schemes it can employ, etc. The absence of curly braces “{” and “}” around the Client-Hello message indicates that the message may be sent as clear text.

Upon receipt or interception of the Client-Hello message, CSI 230 notifies SSI 250 of the requested connection. This notification message is depicted as “{Begin} Ki” in FIG. 2, although it may simply comprise the Client-Hello message originated by client 210. The use of curly braces and “Ki” indicates that this message may be encrypted with the intermediaries' shared key Ki. SSI 250 therefore decrypts the Begin message (with Ki), or opens the Client-Hello if it was forwarded, and extracts any necessary information, such as the client seed.

In some alternative embodiments, the CSI may simply forward the client's Client-Hello message in clear text. For example, CSI 230 may operate in a pass-through mode regarding the hello message, and not process or inspect it any manner other than as may be necessary to direct it to the correct server-side intermediary. In yet other embodiments, the Client-Hello message may bypass the CSI.

Upon notification of the client connection request, SSI 250 forwards to the server a Client-Hello message that is identical or similar to the one originated by the client. For example, the server-side intermediary may issue a new Client-Hello message formatted so as to appear to come directly from the client (e.g., using information contained in the original Client-Hello message and/or received from the client-side intermediary), but with an address of SSI 250.

The server responds with several messages/records, including a Server-Hello (SH) message, a Certificate message that includes a digital certificate issued to the server (SC), and a Server-Hello-Done (SHD) message. The server may also issue a Certificate-Request (CR) message requesting the client's digital certificate if, for example, authentication of the client (or the SSI) is desired.

The SH message includes a server seed (e.g., another random number), and may include other information, such as elected options for protocol/version/encryption/compression, etc. The SSI may or may not verify server certificate SC to ensure it is actually communicating with server 270 and not an imposter.

In order to terminate and establish the server session portion of the split-terminated secure communication between client 210 and server 270, and assuming server certificate SC was successfully verified (if verification was sought), SSI 250 continues with the operative communication protocol handshaking by composing and issuing a Client-Key-Exchange (CKE) message, a Change-Cipher-Specification (CCS) message, and a Finish (F) message.

The CKE message comprises another secret (e.g., a Pre-Master-Secret) to be used in generating a server session key, which is encrypted with the public key associated with server certificate SC. The CCS message specifies that the communicants are to start encrypting their communications using the server session key, which is denoted herein as “Ks”. The Finished message signals that the handshaking is complete from the SSI's point of view, and may comprise an encrypted hash over preceding handshaking messages.

If the server has not encountered any errors during the handshaking, it issues Change-Cipher-Specification (CCS) and Finish (F) messages to SSI 250 to complete the handshaking for the server session. In some implementations, the server will authenticate the server-side intermediary by verifying a certificate (e.g., the proxy server certificate) sent by the SSI.

Because all data needed to compute server session key Ks are now known to SSI 250 and server 270, they may do so at time sequence 284.

In addition to completing the handshaking with server 270, SSI 250 forwards toward the client the Server-Hello and Server-Hello-Done messages issued by server 270, or may generate and send replacement messages. Instead of forwarding server certificate SC, however, the server-side intermediary sends its proxy server certificate PSC. If client authentication is desired, the messages sent by SSI 250 will include a Certificate-Request message.

CSI 230 receives and decrypts the communication from SSI 250, and forwards the messages and PSC to client 210. At time sequence 286, the client may verify the proxy server certificate.

The client then continues with the communication protocol handshaking process by composing and issuing a Client-Key-Exchange (CKE) message, a Change-Cipher-Specification (CCS) message, and a Finish (F) message. The CKE message comprises another secret (e.g., a Pre-Master-Secret) to be used in generating a client session key, which is encrypted with the public key from server certificate PSC. The CCS message specifies that the communicants (client 210 and SSI 250) are to start encrypting their communications using the client session key, which is denoted herein as “Kc”. The Finished message signals that the handshaking is complete from the client's point of view, and may comprise an encrypted hash over the preceding handshaking messages.

If client authentication was requested, the messages sent by the client include a Certificate message comprising a copy of a digital certificate (CC) issued to the client by a suitable Certificate Authority. Illustratively, certificate CC may have been issued by a CA that is internal to an organization comprising both client 210 and server 270, and may or may not have been issued by a CA whose public certificate is available on server-side intermediary 250 and the server. For example, the server-side intermediary may act as a CA and issue certificate CC.

In some scenarios, client 210 may be able to perform certain cryptographic operations (including participating in the handshaking process of FIG. 2) while merely having control of or access to the private client key instead of actual possession. For example, the private key may be stored on a smartcard or similar device, and the client may be able to request the device to perform a particular operation.

Because all data needed to compute client session key Kc (e.g., client and server seeds, pre-Master-Secret) are now known to the client, it may do so at time sequence 288.

CSI 230 receives and forwards the client's messages to SSI 250, preferably by encrypting them with the intermediaries' key Ki.

Upon receipt, server-side intermediary 250 extracts and forwards the payload of the CKE message to key server 280 (i.e., the pre-Master-Secret), encrypted with the public key of the PSC certificate (designated Kpsc), with or as part of a decryption request. This transaction is depicted as “{PMS} Kpsc” in FIG. 2. SSI 250 may also send the proxy server certificate, the public key that was used to encrypt the CKE message, or indicate in some other way which private key the key server should use to decrypt the message. This private key may be identified as Kpsc'.

The key server decrypts the pre-Master-Secret and returns the decrypted information (the pre-Master-Secret) to the SSI. The SSI may or may not verify client certificate CC (if it is sent).

If no errors were encountered by SSI 250 during the handshaking with client 210, the SSI issues Change-Cipher-Specification (CCS) and Finish (F) messages toward client 210 to complete the client session. SSI 250 can therefore compute client session key Kc at time index 290.

SSI 250 forwards the client session key Kc, to CSI 230, any time after the SSI computes the key at time sequence 290. In the illustrated embodiment, the client-server connection may therefore be deemed split-terminated as of time sequence 290, or some time thereafter, when one or both intermediaries are able to read and manipulate (e.g., to optimize) communications exchanged between the client and the server.

As one of skill in the art will recognize, the handshaking process involved in establishing the secure client and server sessions may include other data exchanges and messages not mentioned herein. For example, Certificate-Verify (CV) messages may accompany one or more certificates (e.g., SC, PSC, CC) when transmitted by their owners, and comprise signatures over handshaking messages previously exchanged, in order to verify that the communicants have (or have access to) the private keys that correspond to the certificates. The SSI would, in the illustrated embodiment, submit to key server 280 a CV message destined for client 210 or server 270, in order to have the private key associated with the corresponding certificate (e.g., PSC) applied.

Client 210 and server 270 may now securely conduct transactions. In the illustrated embodiment, each client request is encrypted using Kc and submitted to CSI 230 by client 210. The CSI decrypts it using its copy of Kc.

The CSI may then optimize or otherwise manipulate the request, and encrypts it with Ki before transmitting it to SSI 250. At the server-side intermediary, the optimized message is decrypted with Ki, processed, re-encrypted with Ks and delivered to the server. The reverse process is then followed to securely deliver any server response to client 210.

In FIG. 2, the illustrated sequence of directed vectors does not necessarily indicate exact timing and/or sequencing of the corresponding actions and messages. For example, a message received by one entity may not be immediately forwarded, but rather may be processed or manipulated in some manner before the next message in sequence is issued. In addition, the various actions (e.g., verifying a certificate, computing a session key) need not occur in the exact order illustrated in FIG. 2.

The handshaking process of FIG. 2 satisfies an applicable security protocol (e.g., TLS, SSL), and avoids exposure of private keys of SSI 250 and/or server 270, even while allowing server-side and client-side network intermediaries to split-terminate and participate in the secure client-server connection (e.g., to optimize transactions).

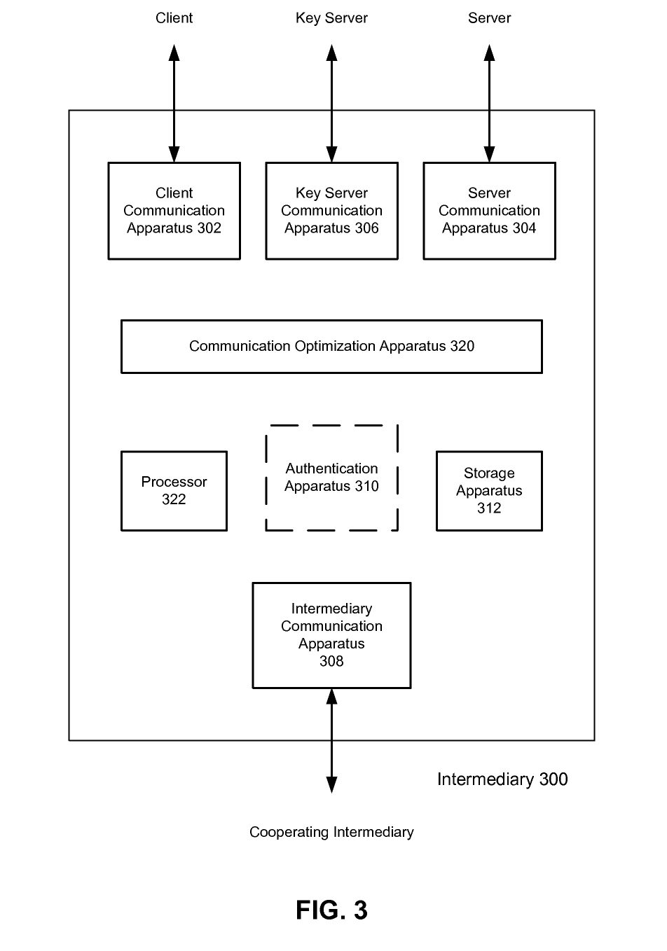

FIG. 3 is a block diagram of hardware apparatus that may be employed to facilitate establishment of a secure split-terminated client-server without exposing a private cryptographic key, according to some embodiments.

Intermediary 300 of FIG. 3 comprises communication apparatuses 302, 304, 306, 308 for communicating with a client, a server, a key server, and another intermediary, respectively. Depending on an intermediary's role (e.g., as a server-side or client-side intermediary), one or more of the communication apparatuses, and/or other components described below, may be omitted. Further, any or all of these communication apparatuses may be combined or divided in other embodiments.

The communication apparatuses are adapted to transmit communications to, and receive communications from, the indicated entities. The communication apparatuses may also be adapted to assemble/extract components of a communication, and/or to encrypt/decrypt a communication as needed.

Depending on the entity with which a communication apparatus interacts, communications may be sent encrypted with appropriate keys (e.g., a client session key, a server session key, a key shared with a key server, an intermediary key). As discussed above, key server communication apparatus 306 may dispatch data to a key server to be encrypted with a private key stored on the key server, and the data may be sent and/or received in plain text or encrypted with another key (e.g., a session key established between intermediary 300 and the key server). Similarly, intermediary 300 may transmit data encrypted with a private key stored on the key server and receive the decrypted data in plain text or encrypted with another key.

Intermediary 300 also comprises storage apparatus 312 (e.g., a memory) for temporarily storing various information. Such information may include, but is not limited to, a proxy server digital certificate, copies of one or more client and/or server certificates, a session key shared with a client and/or server, other encryption/decryption keys, client seeds and/or server seeds observed during a handshaking process, etc.

Optional authentication apparatus 310 is adapted to authenticate a client, a server, and/or another entity. Apparatus 310 may therefore be configured to verify a digital certificate, validate a Certificate-Verify message, and/or take other action. The authentication apparatus may communicate with an external entity to facilitate authentication of an entity or validation of a communication (e.g., a key server, a certificate authority), and may therefore invoke one or more of communication apparatuses 302, 304, 306, 308 or another communication apparatus not depicted in FIG. 3.

Communication optimization apparatus 320 is adapted to optimize communications exchanged with another intermediary. Thus, apparatus 320 may compress (or expand), encrypt (or decrypt), cache or otherwise enhance the efficiency of client-server communications.

Processor 322 is adapted to assist intermediary 300 in performing the various operations described in conjunction with FIG. 3. Thus, it may execute various algorithms stored as software and/or firmware.

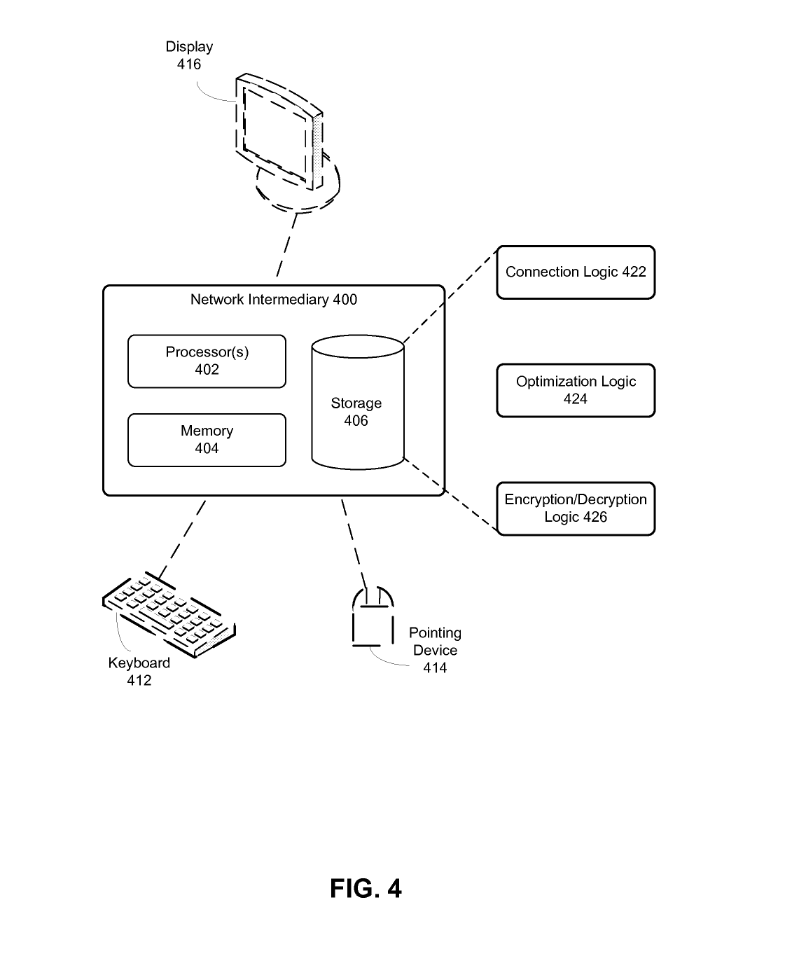

FIG. 4 is a block diagram of a network intermediary that may be employed to facilitate establishment of a secure split-terminated client-server connection without exposing a private cryptographic key, according to some embodiments.

Network intermediary 400 of FIG. 4 comprises processor(s) 402, memory 404, and storage 406, which may comprise one or more optical and/or magnetic storage components. Network intermediary 400 may be coupled (permanently or temporarily) to keyboard 412, pointing device 414, and display 416.

Storage 406 of the network intermediary stores logic that may be loaded into memory 404 for execution by processor(s) 402. Such logic includes connection logic 422, optimization logic 424, and encryption/decryption logic 426.

Connection logic 422 comprises processor-executable instructions for establishing, maintaining and terminating communication sessions and connections. Such sessions may be with other network intermediaries, clients, servers, and/or key servers. Thus, the connection logic may be responsible for conducting protocol handshaking, establishing communication parameters, generating session keys, requesting encryption or decryption of information, etc.

Optimization logic 424 comprises processor-executable instructions for optimizing a communication. Such optimization may involve replacing all or a portion of the communication with substitute content for transmission to another network intermediary (e.g., for the purpose of de-duplication), exchanging substitute content in a communication received from another intermediary for its original content, compressing (or decompressing) content of a communication, etc.

Encryption/decryption logic 426 comprises processor-executable instructions for encrypting/decrypting communications (or portions of communications) received at or prepared for transmission from intermediary 400.

In other embodiments, intermediary 400 may include other logic, such as authentication logic for verifying a digital certificate, validating a Certificate-Verify message, and/or taking other action to authenticate a client (or other entity) or to validate a communication.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

1. A method of establishing a secure split-terminated communication connection between a client and a server, at a first intermediary within a path of communication between the client and the server, the method comprising:
obtaining a proxy certificate identifying the first intermediary with a name of the server;
storing on a key server a private key associated with the proxy certificate, wherein the key server is not within the path of communication;
exchanging handshaking messages with the client and the server to facilitate establishment of the secure split-terminated communication connection;
delivering to the key server, for decryption with the private key, at least one handshaking message originated by the client; and
computing multiple session keys, including a first session key for exchanging communications with the client and a second session key for exchanging communications with the server.

2. The method of claim 1, further comprising:
delivering to the key server, for encryption with the private key, at least one handshaking message destined for the server.

3. The method of claim 1, further comprising:
authenticating the key server prior to establishing a persistent connection between the first intermediary and the key server, wherein the key server also authenticates the first intermediary.

4. The method of claim 1, further comprising prior to said exchanging:
establishing a secure communication connection between the first intermediary and a second intermediary within the path of communication; and
during said establishing, delivering to the key server, for decryption with the private key, at least one handshaking message received from the second intermediary.

5. The method of claim 4, comprising:
at the second intermediary:
receiving from the client a request encrypted with the first session key;
decrypting the encrypted request;
optimizing the request; and
forwarding the optimized request to the first intermediary; and
at the first network intermediary:
un-optimizing the optimized request to retrieve the request;
re-encrypting the request with the second session key; and
forwarding the re-encrypted request to the server.

6. The method of claim 1, further comprising prior to said exchanging:
obtaining an intermediary certificate;
storing a second private key associated with the intermediary certificate on the key server;
establishing a secure communication connection between the first intermediary and a second intermediary within the path of communication; and
during said establishing, delivering to the key server, for decryption with the second private key, at least one handshaking message received from the second intermediary.

7. A non-transitory computer-readable medium storing instructions that, when executed by a processor, cause the processor to perform a method of establishing a secure split-terminated communication connection between a client and a server, at a first intermediary within a path of communication between the client and the server, the method comprising:
obtaining a proxy certificate identifying the first intermediary with a name of the server;
storing on a key server a private key associated with the proxy certificate, wherein the key server is not within the path of communication;
exchanging handshaking messages with the client and the server to facilitate establishment of the secure split-terminated communication connection;
delivering to the key server, for decryption with the private key, at least one handshaking message originated by the client; and
computing multiple session keys, including a first session key for exchanging communications with the client and a second session key for exchanging communications with the server.

8. The non-transitory computer-readable medium of claim 7, wherein the method further comprises:
delivering to the key server, for encryption with the private key, at least one handshaking message destined for the server.

9. The non-transitory computer-readable medium of claim 7, wherein the method further comprises:
establishing a secure communication connection between the first intermediary and a second intermediary within the path of communication; and
during said establishing, delivering to the key server, for decryption with the private key, at least one handshaking message received from the second intermediary.

10. The non-transitory computer-readable medium of claim 7, wherein the method further comprises:
obtaining an intermediary certificate;
storing a second private key associated with the intermediary certificate on the key server;
establishing a secure communication connection between the first intermediary and a second intermediary within the path of communication; and
during said establishing, delivering to the key server, for decryption with the second private key, at least one handshaking message received from the second intermediary.

11. An apparatus for establishing a secure split-terminated communication connection between a client and a server, at a first intermediary within a path of communication between the client and the server, comprising:
one or more processors; and
a memory storing instructions that, when executed by the one or more processors, cause the apparatus to:
obtain a proxy certificate identifying the first intermediary with a name of the server;
store on a key server a private key associated with the proxy certificate, wherein the key server is not within the path of communication;
exchange handshaking messages with the client and the server to facilitate establishment of the secure split-terminated communication connection;
deliver to the key server, for decryption with the private key, at least one handshaking message originated by the client; and
compute multiple session keys, including a first session key for exchanging communications with the client and a second session key for exchanging communications with the server.

12. The apparatus of claim 11, further comprising:
delivering to the key server, for encryption with the private key, at least one handshaking message destined for the server.

13. The apparatus of claim 11, further comprising:
authenticating the key server prior to establishing a persistent connection between the first intermediary and the key server, wherein the key server also authenticates the first intermediary.

14. The apparatus of claim 11, further comprising prior to said exchanging:
establishing a secure communication connection between the first intermediary and a second intermediary within the path of communication; and
during said establishing, delivering to the key server, for decryption with the private key, at least one handshaking message received from the second intermediary.

15. The apparatus of claim 14, comprising:
at the second intermediary:
receiving from the client a request encrypted with the first session key;
decrypting the encrypted request;
optimizing the request; and
forwarding the optimized request to the first intermediary; and
at the first network intermediary:
un-optimizing the optimized request to retrieve the request;
re-encrypting the request with the second session key; and
forwarding the re-encrypted request to the server.

16. The apparatus of claim 11, further comprising prior to said exchanging:
obtaining an intermediary certificate;
storing a second private key associated with the intermediary certificate on the key server;
establishing a secure communication connection between the first intermediary and a second intermediary within the path of communication; and
during said establishing, delivering to the key server, for decryption with the second private key, at least one handshaking message received from the second intermediary.
